(19) United States
(12) Patent Application Publication
(10) Pub. No.: US 2002/0167439 A1
(43) Pub. Date: Nov. 14, 2002

(54) Proximity sensor and method for operating a proximity sensor

(76) Inventors: Richard Bloch, Nussbaumen (CH); Philippe Pretre, Baden-Dattwil (CH)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/114,771

(22) Filed: Apr. 2, 2002

(30) Foreign Application Priority Data
Apr. 2, 2001 (DE) 101 16 411.4

(51) Int. Cl. G01S 13/58

(52) U.S. Cl. 342/28; 342/61; 342/68; 342/102; 342/114; 342/175

(57) ABSTRACT

An electronic circuit for a proximity sensor, which is target-independent and is based on a phase projection transformation, is configured in such a way that the oscillating circuit can be driven by a square-wave voltage. A synchronous demodulator is used for the phase projection transformation. The electronic circuit can be miniaturized and only low requirements are placed on the stability of the feed voltage. A method for operating a proximity sensor is also provided.

### BACKGROUND OF THE INVENTION

1. Field of the Invention:

The invention relates to a proximity sensor and to a method for operating a proximity sensor.

Known proximity sensors contain an oscillating circuit with a capacitor and a coil, whose impedance changes as a metallic initiator or target approaches. In the case of an inductive proximity sensor, the inductance of the oscillating circuit coil is influenced by the initiator, but in the case of a capacitive proximity sensor, on the other hand, the capacitance of the oscillating circuit capacitor is influenced by the initiator. As a result of the change in the impedance of the oscillating circuit, the amplitude of the oscillating circuit signal changes. This signal is rectified and, in the case of a proximity switch, is converted by a discriminator into a signal indicating the presence or absence of the initiator.

The oscillating circuit amplitude depends on the oscillating circuit frequency, on the position of the initiator, that is to say its distance from the sensor, and the material of the initiator. In the case of different initiators, the discriminator will generally respond at different switching distances, that is to say at a different distance between initiator and sensor. For this reason, commercially available proximity switches are initiator-material specific, and reduction factors in the switching distance are defined. For example, in the case of inductive proximity switches, the switching distance for a copper target is only 30% of the switching distance of tool steel, primarily because of the different magnetic properties.

### SUMMARY OF THE INVENTION

It is accordingly an object of the invention to provide a proximity sensor which overcomes the above-mentioned disadvantages of the heretofore-known proximity sensors of this general type and which is an initiator-independent proximity sensor that operates such that sinusoidal signals can be dispensed with.

With the foregoing and other objects in view there is provided, in accordance with the invention, a target-independent proximity sensor for a phase projection transformation, including:

a square-wave signal generator;

a phase delay element;

an oscillating circuit;

a synchronous demodulator operating as a multiplier;

an inverter connected between the oscillating circuit and the synchronous demodulator;

a low-pass filter connected to the synchronous demodulator; and

the square-wave signal generator being connected to the synchronous demodulator both, via the phase delay element and via the oscillating circuit.

In other words, a target-independent proximity sensor for phase projection transformation, having a signal generator, a phase delay element, an oscillating circuit or tuned circuit, a multiplier and a low-pass filter, the signal generator being connected to the multiplier both via the phase delay element and via the oscillating circuit, and the multiplier in turn being connected to the low-pass filter, is characterized in that the signal generator is a square-wave signal generator and the multiplier is a synchronous demodulator, and an inverter is provided between the tuned circuit and the synchronous demodulator.

The nub of the invention is to use square-wave signals, such as integrated semiconductor components are able to generate, in a proximity sensor. A synchronous demodulator, which is driven by a phase-shifted reference signal, ensures the phase projection transformation of the oscillating circuit signal to be evaluated. As a result of the use of digital components, a sensor which saves power and space is achieved.

In a first embodiment of the proximity sensor according to the invention, the oscillating circuit frequency is at least approximately equal to the target-dependent resonant frequency of the oscillating circuit.

According to another feature of the invention, the signal generator includes a frequency divider; and the phase delay element includes a shift register.

In a second embodiment of the proximity sensor according to the invention, the latter is supplemented by a comparator and used as a proximity switch. The comparator compares a signal that characterizes the initiator distance with a threshold value. A threshold value generator and the signal generator are both connected to one and the same DC feed voltage, which achieves independence of the time fluctuations of the latter.

According to another feature of the invention, a comparator is connected to the low-pass filter; and a threshold value generator is connected to the comparator.

According to yet another feature of the invention, the signal generator and the threshold value generator are connected to a DC feed voltage.

With the objects of the invention in view there is also provided, a method for operating a proximity sensor, the method includes the steps of:

providing a proximity sensor having a square-wave signal generator, a phase delay element, an oscillating circuit, an inverter, a synchronous demodulator, and a low-pass filter;

generating, with the square-wave signal generator, a square-wave signal U1 which is applied to the oscillating circuit and which, shifted by a phase ξ, drives the synchronous demodulator; and

selectively switching in an alternating manner, with the synchronous demodulator, an oscillating circuit signal U4 and an inverted oscillating circuit signal \overline{U4} to the low-pass filter.

In other words, a method for operating a proximity sensor with phase projection transformation as defined above is characterized in that the signal generator generates a square-wave signal U1 which, firstly, is applied to the oscillating circuit and, secondly, shifted by a phase ξ, drives the synchronous demodulator, which alternately switches an oscillating circuit signal U4 or an inverted oscillating circuit signal \overline{U4} to the low-pass filter.

Another mode of the invention includes the step of, comparing, with a comparator, a low-pass filtered signal U6 with a threshold value U9 such that the proximity sensor operates as a proximity switch.

Other features which are considered as characteristic for the invention are set forth in the appended claims.

Although the invention is illustrated and described herein as embodied in a proximity sensor and a method for its operation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of an electronic circuit for a proximity sensor according to the invention; and

FIG. 2 is a block diagram of an expanded circuit according to the invention for a use of the proximity sensor as a switch.

### DESCRIPTION OF THE PREFERRED EMBODIMENTS

A proximity sensor which is independent of the material of an initiator or target is described in Published, Non-Prosecuted German Patent Application No. 19947380.3, which is assigned to the assignee of the instant application and whose disclosure is incorporated as an integral part of the following description. In this case, a component that is independent of the initiator material is split off from a stationary complex system variable, such as the impedance Z of the oscillating circuit or the amplitude U of the oscillating circuit signal, which depends on the position and the material of the initiator or trigger. This procedure corresponds to a projection of the continuously updated system variable used by the proximity sensor onto a direction defined by the angle ξ that depends on the oscillating circuit frequency, from which the initiator distance d can then be determined. This phase projection transformation includes multiplication of the oscillating circuit signal by a reference signal that is phase-shifted by the angle ξ, this preferably being carried out in analog form in a lock-in amplifier. The generation, stabilization and multiplication of the sinusoidal signals used in the above-mentioned application is relatively complicated, viewed in electronic terms, and is suitable only to a restricted extent for miniaturization of the sensor. These disadvantages are overcome by the proximity sensor described below.

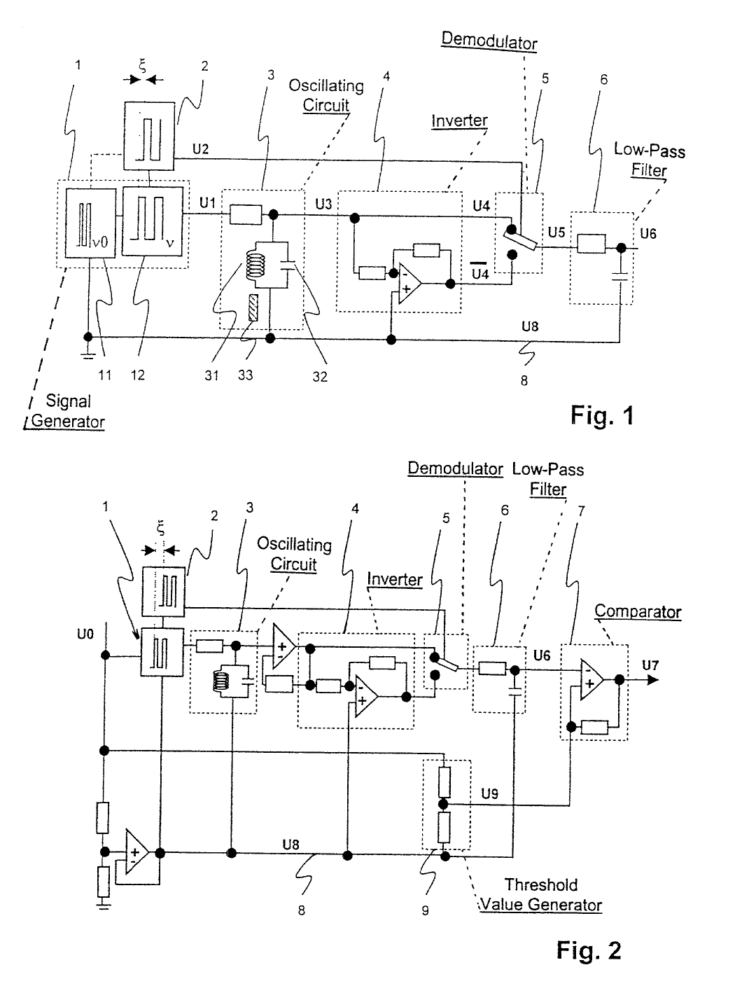

Referring now to the figures of the drawings in detail, in which same reference symbols are used for corresponding structural parts, and first, particularly, to FIG. 1 thereof, there is shown a first basic schematic diagram of the evaluation electronics of a proximity sensor according to the invention. A signal generator 1 generates a suitable periodic signal or a first voltage U1, which are supplied to a phase delay element 2 and an oscillating circuit 3. The phase delay element 2 generates a signal U2 with a phase delayed by the angle ξ+π/2 with respect to U1. The oscillating circuit or tuned circuit 3, the actual heart of the sensor, includes a coil 31 and a capacitor 32; its impedance Z3 is determined substantially by the distance of a target or initiator 33 to be detected. The oscillating circuit signal on the output side or the voltage on the output side is designated by U3. An inverter 4 connected downstream generates, in addition to U3 (≡U4) a further signal \overline{U4} inverted with respect to it. These two signals are supplied to a synchronous demodulator 5. The demodulator 5 is controlled by the phase-shifted signal U2 and switches through one of the two signals U4 or \overline{U4} as desired. The demodulated signal U5 generated in this way is then filtered by the low-pass filter 6 and the resulting DC voltage U6, as will be shown further below, is proportional to the intended target-independent component of the oscillating circuit signal U3.

According to the invention, the signal U1 generated by the signal generator 1 is a square-wave signal and not a sinusoidal signal. It is preferably generated by a field-programmable gate module (field programmable gate array). The demodulator 5 replaces the multiplier of the strict analog solution, has substantially the function of a relay and preferably includes an integrated analog changeover switch such as can be obtained under the designation MAXIM 4544, for example. The significant fact here is that its resistance in the forward branch is low as compared with the resistance of the following low-pass filter 6. Signal generator 1, oscillating circuit 3, inverter 4 and low-pass filter 6 are connected to a common reference potential via a connection 8 which, in the case of the embodiment according to FIG. 1, is also connected to ground. The use of square-wave signals and integrated digital components permits miniaturization and a power-saving configuration, which is suitable in particular for wireless proximity switches with inductive power feed.

The action of the synchronous demodulator 5 in conjunction with the inverter 4, that is to say selectively switching through U4 or \overline{U4}, corresponds to a multiplication of the normalized, phase-shifted reference signal U2 by the oscillating circuit signal U3 present on an input of the demodulator 5. For square-wave signals, the Fourier decomposition with odd-numbered multiples of the oscillating circuit frequency ν applies, so that

U₂·U₃∝[sin(2πνt+(ξ+π/2))+. . .]·[A₁sin(2πνt+φ₁)+A₃sin (6πνt+φ₃)+. . .], ∝A₁[cos (φ₁−(ξ+π/2))−cos (6πνt+φ₁+(ξ+π/2))]+. . . .

following the low-pass filtering, only DC current terms remain, that is to say

$${U}_{2} \cdot {U}_{3} ∝ {\sum }_{n} \frac{2 {A}_{n}}{2 n - 1} cos ( {ϕ}_{n} - ( 2 n - 1 ) ( ξ - π / 2 ) ) ∝ [ {A}_{1} sin ( {ϕ}_{1} - ξ ) + … ] .$$

In general, therefore, with A₁>>A₃, the signal U6 is, to a sufficient approximation, equal to the intended projection of the oscillating circuit signal U3 onto the direction determined by the angle ξ. If, in addition, the oscillating circuit 3 already forms a filter element with resonance in the vicinity of the oscillating circuit frequency ν, the amplitude A₁ of the fundamental frequency νwill dominate even more. The oscillating circuit then filters out all harmonics, and the signal U3 is at least approximately a sinusoidal function, as in the case of analog excitation of the oscillating circuit. For stability reasons, however, even in this case it is better to select an oscillating circuit frequency ν which differs by at least about 5% from the resonant frequency.

The square-wave signal generator 1 preferably includes a device 11 for generating a basic frequency ν0, which is subsequently divided by the factor N by a frequency divider 12 to the value of the desired oscillating circuit frequency ν. The phase delay element 2 includes a shift register with n cells, which is clocked by the basic frequency ν0. At each clock, that is to say 1/ν0 times per second, the binary content of each cell is moved onward by one cell, so that overall, between U2 and U1, a phase difference of n/N·360° corresponding to the angle ξ+π/2 may be achieved.

FIG. 2 shows an expanded basic schematic diagramm of the sensor electronics, which is suitable for use of the proximity sensor as a proximity switch. In the case of a proximity switch, the signal U6 is supplied onward to a comparator or a discriminator 7. The latter converts the signal as a function of a discriminator threshold U9, associated with a specific switching distance, into a signal whose sign represents the states “initiator present” and “initiator absent”. The comparator 7 illustrated in FIG. 2 is further extended by a feedback between an amplifier output and an amplifier input. This is done in order to introduce a switching distance hysteresis, which is needed for stable operation of the switch. If the sensor is operated in clocked mode for power-savings purposes, that is to say is connected to a supply voltage U0 typically only during one tenth of the time, a hysteresis voltage must additionally be stored in a memory module.

The signal generator 1 or the entire sensor is fed by a DC feed voltage U0. In particular in the aforementioned wireless proximity switches, this feed voltage U0 is not constant, however, but is subject to time fluctuations. In the embodiment according to FIG. 2, the connection 8 is not made to ground but to a potential U8, which assumes a value between zero and the feed voltage U0, that is to say U0/2, for example. Through the use of the two resistors of a threshold value generator 9, a comparative signal or threshold value U9 is defined, which lies between U8 and U0 and is supplied to the comparator 7 together with the low-pass filtered signal U6 lying in the same range. In this embodiment, in a manner similar to a measuring bridge, fluctuations in the feed voltage U0 are automatically tracked or carried along proportionally at all the internal voltage levels, such as the threshold value and the signal. The result is a switching response of the proximity switch which is independent of the feed voltage U0, so that no excessive demands have to be made on its stability.

The basic frequency ν0 is, for example, 1.8 MHz, and the oscillating circuit frequency ν after the frequency division by the factor 6 is still 300 kHz which, given an appropriately selected oscillating circuit inductance or impedance, corresponds at least approximately to the resonant frequency of the oscillating circuit for an average target distance. With only one cell in the shift register, a phase shift of 600° results. The DC supply feed voltage U₀ is typically 3 V.

We claim:

1. A target-independent proximity sensor for phase projection transformation, comprising:
a square-wave signal generator;
a phase delay element;
an oscillating circuit;
a synchronous demodulator as a multiplier;
an inverter connected between said oscillating circuit and said synchronous demodulator;
a low-pass filter connected to said synchronous demodulator; and
said square-wave signal generator being connected to said synchronous demodulator both, via said phase delay element and via said oscillating circuit.

2. The proximity sensor according to claim 1, wherein:
said oscillating circuit has a resonant frequency; and
said oscillating circuit oscillates at an oscillating circuit frequency at least substantially equal to the resonant frequency of said oscillating circuit.

3. The proximity sensor according to claim 1, wherein:
said signal generator includes a frequency divider; and
said phase delay element includes a shift register.

4. The proximity sensor according to claim 1, including:
a comparator connected to said low-pass filter; and
a threshold value generator connected to said comparator.

5. The proximity sensor according to claim 4, wherein said square-wave signal generator and said threshold value generator are connected to a DC feed voltage.

6. A method for operating a proximity sensor, the method which comprises:
providing a proximity sensor having a square-wave signal generator, a phase delay element, an oscillating circuit, an inverter, a synchronous demodulator, and a low-pass filter;
generating, with the square-wave signal generator, a square-wave signal which is applied to the oscillating circuit and which, shifted by a given phase, drives the synchronous demodulator; and
selectively switching in an alternating manner, with the synchronous demodulator, an oscillating circuit signal and an inverted oscillating circuit signal to the low-pass filter.

7. The method for operating a proximity sensor according to claim 6, which comprises performing a proximity switch operation by comparing, with a comparator, a low-pass filtered signal from the low-pass filter with a threshold value.
